(19) United States
(12) Patent Application Publication
(10) Pub. No.: US 2024/0378646 A1
(43) Pub. Date: Nov. 14, 2024

(54) METHOD AND APPARATUS FOR ESTIMATING PRODUCT LIFETIME BASED ON MULTI-STRESS ACCELERATED TEST, AND COMPUTER DEVICE

(71) Applicant: CHINA ELECTRONIC PRODUCT RELIABILITY AND ENVIROMENTAL TESTING RESEARCH INSTITUTE, Guangzhou (CN)

(72) Inventors: Guangze PAN, Guangzhou (CN); Dan Li, Guangzhou (CN); Bochen Chen, Guangzhou (CN); Lijun Sun, Guangzhou (CN); Yuanhang Wang, Guangzhou (CN); Wenwei Liu, Guangzhou (CN); Jianfeng Yang, Guangzhou (CN); Xiaojian Ding, Guangzhou (CN)

(73) Assignee: CHINA ELECTRONIC PRODUCT RELIABILITY AND ENVIROMENTAL TESTING RESEARCH INSTITUTE, Guangzhou (CN)

(21) Appl. No.: 18/629,393

(22) Filed: Apr. 8, 2024

(30) Foreign Application Priority Data
May 8, 2023 (CN) 2023105065514

(51) Int. Cl. G06Q 30/02

(52) U.S. Cl. CPC G06Q 30/0278

(57) ABSTRACT

The present disclosure discloses a method and apparatus for estimating product lifetime based on a multi-stress accelerated test, and a device. This method can be applied in the field of data processing technologies, specifically including: determining, in response to a lifetime estimation request for a target product, a target characteristic lifetime of the target product based on a target stress condition for the target product and correspondence relationships between candidate stress conditions and candidate characteristic lifetimes; and determining, based on an optimal lifetime model for the type to which the target product belongs and the target characteristic lifetime, a target average life of the target product.

### CROSS-REFERENCE TO RELATED APPLICATIONS

This application claims the priority to Chinese patent application No. 2023105065514, filed on May 8, 2023, which is hereby incorporated by reference in its entirety.

### TECHNICAL FIELD

The present disclosure relates to the field of data processing technologies, and in particular, to a method and apparatus for estimating product lifetime based on a multi-stress accelerated test, and a computer device.

### BACKGROUND

In related art, the objective of an accelerated test is to estimate and predict the lifetime of the product under normal conditions by achieving the same failure effect in a short period using increased stress. Because the accelerated test can quickly estimate the lifetime of the product in a relatively short period, it is widely used in the lifetime estimation of high-reliability and long-lifetime products.

### SUMMARY

In a first aspect, the present disclosure provides a method for estimating product lifetime based on a multi-stress accelerated test. This method includes:

determining, in response to a lifetime estimation request for a target product, a target characteristic lifetime of the target product based on a target stress condition for the target product and correspondence relationships between candidate stress conditions and candidate characteristic lifetimes, the correspondence relationships between the candidate stress conditions and the candidate characteristic lifetimes being obtained by processing performance parameter values of respective sample products under different groups of stress accelerated tests, the sample product being of the same type as the target product, and each of the candidate stress conditions includes at least two types of stresses; and
determining, based on an optimal lifetime model for the type to which the target product belongs and the target characteristic lifetime, a target average lifetime of the target product.

In an embodiment, processing the performance parameter values of the respective sample products under different groups of the stress accelerated tests includes:
selecting, based on the performance parameter values of the respective sample products under each group of the stress accelerated tests, an optimal degradation model from candidate degradation models;
determining, based on the optimal degradation model, failure times of the respective sample products under each group of the stress accelerated tests;
selecting, based on the failure times of the respective sample products under each group of the stress accelerated tests, the optimal lifetime model from candidate lifetime models;
determining, based on the optimal lifetime model, and a stress condition corresponding to each group of the stress accelerated tests, total sample characteristic lifetime corresponding to each group of the stress accelerated tests; and
establishing, based on the total sample characteristic lifetime and the stress condition corresponding to each group of the stress accelerated tests, the correspondence relationships between the candidate stress conditions and the candidate characteristic lifetimes.

In an embodiment, selecting, based on the performance parameter values of the respective sample products under each group of the stress accelerated tests, the optimal degradation model from the candidate degradation models, includes:
performing, by using each of the candidate degradation models, a maximum likelihood analysis on the performance parameter values of the respective sample products under each group of the stress accelerated tests, to obtain maximum likelihood function values of the respective sample products under each of the candidate degradation models under each group of the stress accelerated tests; and
selecting, based on a sum of the maximum likelihood function values of the respective sample products under each of the candidate degradation models under each group of the stress accelerated tests, the optimal degradation model from the candidate degradation models.

In an embodiment, determining, based on the optimal degradation model, the failure times of the respective sample products under each group of the stress accelerated tests, includes:
inputting preset failure thresholds of the respective sample products under each group of the stress accelerated tests into the optimal degradation model, to obtain the failure times of the respective sample products under each group of the stress accelerated tests.

In an embodiment, selecting, based on the failure times of the respective sample products under each group of the stress accelerated tests, the optimal lifetime model from the candidate lifetime models, includes:
performing, by using each of the candidate lifetime models, a maximum likelihood analysis on the failure times of the respective sample products under each group of the stress accelerated tests, to obtain maximum likelihood function values of the respective sample products under each of the candidate lifetime models under each group of the stress accelerated tests; and
selecting, based on a sum of the maximum likelihood function values of the respective sample products under each of the candidate lifetime models under each group of the stress accelerated tests, the optimal lifetime model from the candidate lifetime models.

In an embodiment, determining, based on the optimal lifetime model for the type to which the target product belongs and the target characteristic lifetime, the target average lifetime of the target product, includes:
determining a target correspondence relationship based on a model type of the optimal lifetime model and a correspondence relationship between model types, the candidate characteristic lifetimes and candidate average lifetimes; and
determining, based on the target correspondence relationship and the target characteristic lifetime, the target average lifetime of the target product.

In a second aspect, the present disclosure further provides an apparatus for estimating product lifetime based on a multi-stress accelerated test. The apparatus includes:
a first determination module configured to determine, in response to a lifetime estimation request for a target product, a target characteristic lifetime of the target product based on a target stress condition for the target product and correspondence relationships between candidate stress conditions and candidate characteristic lifetimes, the correspondence relationships between the candidate stress conditions and the candidate characteristic lifetimes are obtained by processing performance parameter values of respective sample products under different groups of stress accelerated tests, the sample product is of the same type as the target product, and each of the candidate stress conditions includes at least two types of stresses; and
a second determination module configured to determine, based on an optimal lifetime model for the type to which the target product belongs and the target characteristic lifetime, a target average lifetime of the target product.

In a third aspect, the present disclosure further provides a computer device. The computer device includes a processor and a memory storing computer programs. The computer programs, when executed by the processor, implement the following steps:
determining, in response to a lifetime estimation request for a target product, a target characteristic lifetime of the target product based on a target stress condition for the target product and correspondence relationships between candidate stress conditions and candidate characteristic lifetimes, the correspondence relationships between the candidate stress conditions and the candidate characteristic lifetimes being obtained by processing performance parameter values of respective sample products under different groups of stress accelerated tests, the sample product being of the same type as the target product, and each of the candidate stress conditions includes at least two types of stresses; and
determining, based on an optimal lifetime model for the type to which the target product belongs and the target characteristic lifetime, a target average lifetime of the target product.

In a fourth aspect, the present disclosure further provides a computer-readable storage medium, having computer programs stored therein. The computer programs, when executed by a processor, implement the following steps:
determining, in response to a lifetime estimation request for a target product, a target characteristic lifetime of the target product based on a target stress condition for the target product and correspondence relationships between candidate stress conditions and candidate characteristic lifetimes, the correspondence relationships between the candidate stress conditions and the candidate characteristic lifetimes being obtained by processing performance parameter values of respective sample products under different groups of stress accelerated tests, the sample product being of the same type as the target product, and each of the candidate stress conditions includes at least two types of stresses; and
determining, based on an optimal lifetime model for the type to which the target product belongs and the target characteristic lifetime, a target average lifetime of the target product.

In a fifth aspect, the present disclosure further provides a computer program product including computer programs. The computer programs, when executed by a processor, implement the following steps:
determining, in response to a lifetime estimation request for a target product, a target characteristic lifetime of the target product based on a target stress condition for the target product and correspondence relationships between candidate stress conditions and candidate characteristic lifetimes, the correspondence relationships between the candidate stress conditions and the candidate characteristic lifetimes being obtained by processing performance parameter values of respective sample products under different groups of stress accelerated tests, the sample product being of the same type as the target product, and each of the candidate stress conditions includes at least two types of stresses; and
determining, based on an optimal lifetime model for the type to which the target product belongs and the target characteristic life, a target average lifetime of the target product.

### BRIEF DESCRIPTION OF THE DRAWINGS

FIG. 1 is a schematic diagram illustrating an application environment of a method for estimating product lifetime based on a multi-stress accelerated test in an embodiment.

FIG. 2 is a schematic flow chart of a method for estimating product lifetime based on a multi-stress accelerated test in an embodiment.

FIG. 3 is a schematic flow chart of processing performance parameter values of respective sample products under different groups of stress accelerated tests in an embodiment.

FIG. 4 is a schematic flow chart of selecting an optimal degradation model from candidate degradation models in an embodiment.

FIG. 5 is a schematic flow chart of selecting an optimal lifetime model from candidate lifetime models in an embodiment.

FIG. 6 is a schematic flow chart of determining a target average lifetime of a target product in an embodiment.

FIG. 7 is a schematic flow chart of a method for estimating product lifetime based on a multi-stress accelerated test in another embodiment.

FIG. 8 is a block diagram illustrating a configuration of an apparatus for estimating product lifetime based on a multi-stress accelerated test in an embodiment.

FIG. 9 is a block diagram illustrating a configuration of an apparatus for estimating product lifetime based on a multi-stress accelerated test in another embodiment.

FIG. 10 is a block diagram illustrating a configuration of an apparatus for estimating product lifetime based on a multi-stress accelerated test in yet another embodiment.

FIG. 11 is a diagram illustrating an internal configuration of a computer device in an embodiment.

### DETAILED DESCRIPTION OF THE EMBODIMENTS

In order to make the objectives, technical solutions and advantages of the present disclosure more clearly understood, the application will be further described in detail with the accompanying drawings and embodiments. It should be understood that the specific embodiments described herein are only used to explain the application and not to limit the application.

As the performance of products becomes more and more diverse, the usage scenarios of products become more and more complex. If the product is subjected to a combined effect of multiple stresses, such as temperature, humidity, vibration, etc., during use, multiple stresses need to be applied to the product during the lifetime estimation. Therefore, lifetime estimation methods based on multi-stress accelerated tests are widely used.

However, the traditional lifetime estimation methods based on the multi-stress accelerated tests, when establishing a multi-stress acceleration model, directly use a temperature-humidity dual-stress acceleration model, a temperature-vibration dual-stress acceleration model, or the like, which cannot meet the lifetime estimation request for the product under the accelerated test under the combined effects of multiple stresses.

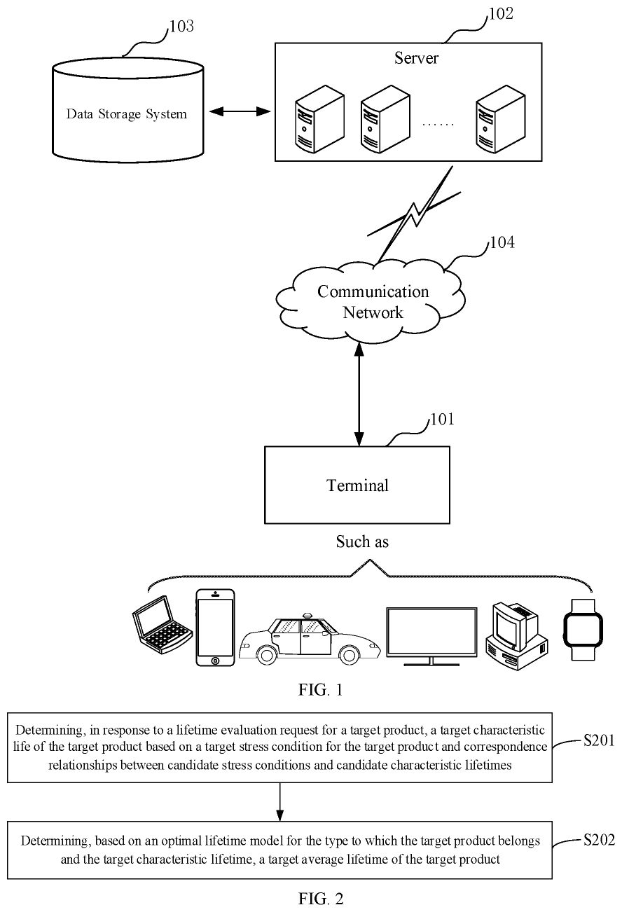

A method for estimating product lifetime based on a multi-stress accelerated test according to embodiments of the present disclosure can be applied to any situation in which the lifetime of a product is estimated. This method may be executed by a server or a terminal, or may also be implemented through an interaction between the server and the terminal. For example, the method for estimating product lifetime based on a multi-stress accelerated test according to an embodiment of the present disclosure can be applied in an application environment as shown in FIG. 1, in which a terminal 101 communicates with a server 102 through a communication network 104. A data storage system 103 can store data that the server 102 needs to process. The data storage system 103 may be integrated with the server 102, or provided in a cloud or other network servers. Specifically, in a case that there is a request for product lifetime estimation, the server 102 determines, in response to the request for the lifetime estimation of a target product, a target characteristic lifetime of the target product according to a target stress condition for the target product, based on correspondence relationships between candidate stress conditions and candidate characteristic lifetimes. Then the server 102 determines a target average lifetime of the target product according to the target characteristic lifetime, based on an optimal lifetime model for the type to which the target product belongs. Further, the server 102 can feed back the target average lifetime of the target product to the terminal 101 by interacting with the terminal 101, and the terminal 101 displays the target average lifetime of the target product to relevant personnel.

The terminal 101 may be, but is not limited to, various personal computers, laptops, smartphones, tablets, internet of things devices, or portable wearable devices. The internet of things devices may be smart speakers, smart TVs, smart air conditioners, smart vehicle-mounted devices, or the like. The portable wearable devices may be smart watches, smart bracelets, head-mounted devices, or the like. The server 102 may be implemented as an independent server or a server cluster composed of multiple servers.

In an embodiment, FIG. 2 is a schematic flow chart of a method for estimating product lifetime based on a multi-stress accelerated test according to the embodiment of the present disclosure. Taking this method applied to the server in FIG. 1 as an example, the method includes the following steps.

In step S201, in response to a lifetime estimation request for a target product, a target characteristic lifetime of the target product is determined based on a target stress condition for the target product and correspondence relationships between candidate stress conditions and candidate characteristic lifetimes.

Optionally, the target product may be any product to be estimated for lifetime, such as computers, mobile phones, or the like. The lifetime estimation request for the target product may be a request for estimating the service life of the target product under a specific stress scenario.

The candidate stress conditions are stress conditions preset by the user for accelerated testing of the sample product. Optionally, each of the candidate stress conditions may include at least two types of stresses. Further, the types of stresses in this embodiment may include, but are not limited to, temperature, humidity, pressure, vibration, and the like. The candidate characteristic lifetime is the service life of the sample product under a candidate stress condition. There are correspondence relationships between the candidate characteristic lifetimes and the candidate stress conditions, and each of the candidate stress conditions corresponds to one candidate characteristic lifetime.

Optionally, the correspondence relationships between the candidate stress conditions and the candidate characteristic lifetimes are obtained by processing performance parameter values of respective sample products under different groups of stress accelerated tests. The stress accelerated test in this embodiment is a test that applies stresses to the product to quickly obtain the product's life. The sample product can be a product used for the stress accelerated test, and the sample product is of the same type as the target product. Each of the candidate stress conditions includes at least two types of stresses. Furthermore, different types of products have different correspondence relationships.

The target stress condition is a condition consisting of the stresses input by the user to be applied to the target product. Optionally, the target stress condition may include multiple types of stresses. The target characteristic lifetime is the service life of the target product obtained based on the target stress condition input by the user.

Specifically, in a case that there is a demand for estimating product lifetime based on a multi-stress accelerated test, the user can input the target stress condition of the target product into a product lifetime estimation tool integrated in the terminal according to the demand, and then the product lifetime estimation tool generates a lifetime estimation request for the target product including the target stress condition, and sends it to the server.

Then, the server acquires, in response to the lifetime estimation request for the target product, the correspondence relationships between the candidate stress conditions associated with the target product and the candidate characteristic lifetimes according to the type of the target product. Further, the server uses the target stress condition as an index to search for a matched candidate characteristic lifetime in the correspondence relationships between the candidate characteristic lifetimes and the candidate stress conditions, and uses the matched candidate characteristic lifetime as the target characteristic lifetime of the target product.

In step S202, a target average lifetime of the target product is determined based on the target characteristic lifetime and an optimal lifetime model for the type of the target product.

Optionally, there may be many types of lifetime models, such as a scale parameter function model, a location-scale parameter function model, a log-location and scale parameter function model, etc. The optimal lifetime model for the type of the target product may be any one of the above lifetime models. Optionally, there is a correspondence relationship between the candidate characteristic lifetime and candidate average lifetime under any one of the lifetime models.

Specifically, in this embodiment, after determining the optimal lifetime model for the type of the target product, the target average lifetime of the target product can be determined based on the target characteristic lifetime of the target product obtained in step S201 and the correspondence relationship between the candidate characteristic lifetime and the candidate average lifetime.

In the above method for estimating product lifetime based on a multi-stress accelerated test, in response to the lifetime estimation request for the target product, the target characteristic lifetime of the target product is determined according to the target stress condition of the target product based on the correspondence relationships between the candidate stress conditions and the candidate characteristic lifetimes. Then, based on the optimal lifetime model for the type to which the target product belongs, the target average lifetime of the target product can be determined. Compared with the method for estimating product lifetime based on a multi-stress accelerated test in the related art, the method in this disclosure establishes the correspondence relationships between the candidate stress conditions and the candidate characteristic lifetimes, which can realize the lifetime estimation request of any stress condition of the target product, solving the problem that the product lifetime can only be estimated based on a dual-stress accelerated test in the related art, expanding the stress conditions for lifetime estimation of the target product, and meeting the lifetime estimation request based on the accelerated test under the combined effects of multiple stresses.

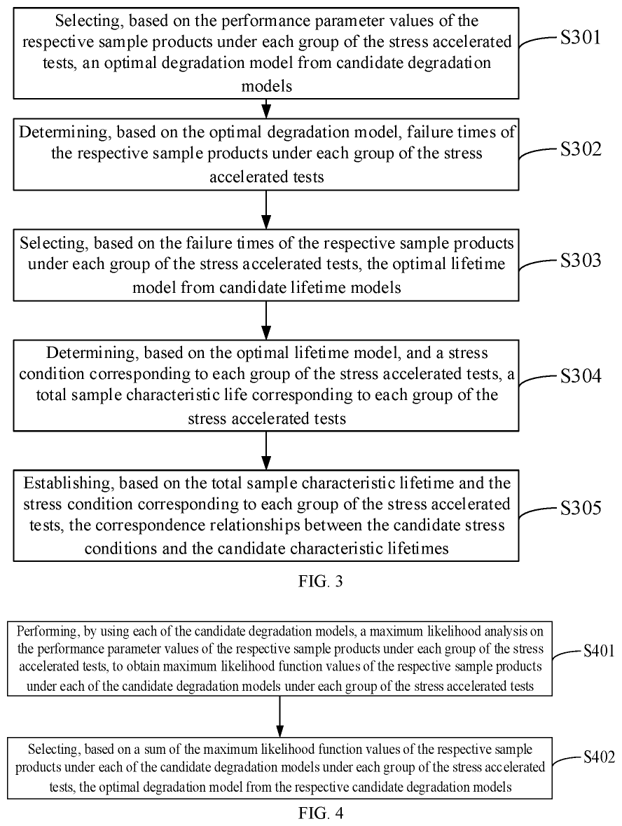

On the basis of the above embodiment, the step of processing the performance parameter values of the respective sample products under different groups of the stress accelerated tests will be described in detail. Optionally, as shown in FIG. 3, the step of processing the performance parameter values of the respective sample products under different groups of the stress accelerated tests specifically includes the following steps.

In step S301, an optimal degradation model is selected from candidate degradation models based on the performance parameter values of the respective sample products under each group of the stress accelerated tests.

Optionally, the performance parameter values of the respective sample products are the performance values of the respective sample products under each group of the stress accelerated tests, for example, a voltage value is 10V, a current value is 10 A, etc. For example, it is assumed that there are c groups of stress accelerated tests with different stress levels, and k=1, 2, ···, c. The number of products under each group of stress levels is n, and the product serial numbers are 1, 2, ···, i, ···, n, and i=1, 2, ···, n. A total of m tests were carried out during the test process, and the test times were x₁, x₂, ···, x_{d}, ···, xₘ, d=1, 2, ···, m. Under the k^{th} group of stress accelerated tests, the performance parameter value of the i^{th} product in the d^{th} test is y_{kid}, then the test times and the performance parameter values of the respective sample products under each group of the stress accelerated tests are as shown in Table 1 below.

TABLE 1
test times and performance parameter values of the respective
sample products under each group of the stress accelerated tests

| Accelerated | Product | Test Time and Performance Parameter Value | | | | | | |
|---|---|---|---|---|---|---|---|---|
| Test | Number | x₁ | x₂ | x₃ | . . . | x_{d} | . . . | x [symbol] |
| First Group | 1 | y [symbol] | y [symbol] | y [symbol] | . . . | y [symbol] | . . . | y [symbol] |
| | 2 | y [symbol] | y [symbol] | y [symbol] | . . . | y [symbol] | . . . | y [symbol] |
| | . . . | . . . | . . . | . . . | . . . | . . . | . . . | . . . |
| | i | y [symbol] | y [symbol] | y [symbol] | . . . | y [symbol] | . . . | y [symbol] |
| | . . . | . . . | . . . | . . . | . . . | . . . | . . . | . . . |
| | n | y [symbol] | y [symbol] | y [symbol] | . . . | y [symbol] | . . . | y [symbol] |
| Second Group | 1 | y [symbol] | y [symbol] | y [symbol] | . . . | y [symbol] | . . . | y [symbol] |
| | 2 | y [symbol] | y [symbol] | y [symbol] | . . . | y [symbol] | . . . | y [symbol] |
| | . . . | . . . | . . . | . . . | . . . | . . . | . . . | . . . |
| | i | y [symbol] | y [symbol] | y [symbol] | . . . | y [symbol] | . . . | y [symbol] |
| | . . . | . . . | . . . | . . . | . . . | . . . | . . . | . . . |
| | n | y [symbol] | y [symbol] | y [symbol] | . . . | y [symbol] | . . . | y [symbol] |
| . . . | . . . | . . . | . . . | . . . | . . . | . . . | . . . | . . . |
| k-th Group | 1 | y [symbol] | y [symbol] | y [symbol] | . . . | y [symbol] | . . . | y [symbol] |
| | 2 | y [symbol] | y [symbol] | y [symbol] | . . . | y [symbol] | . . . | y [symbol] |
| | . . . | . . . | . . . | . . . | . . . | . . . | . . . | . . . |
| | i | y [symbol] | y [symbol] | y [symbol] | . . . | y [symbol] | . . . | y [symbol] |
| | . . . | . . . | . . . | . . . | . . . | . . . | . . . | . . . |
| | n | y [symbol] | y [symbol] | y [symbol] | . . . | y [symbol] | . . . | y [symbol] |
| . . . | . . . | . . . | . . . | . . . | . . . | . . . | . . . | . . . |
| c-th Group | 1 | y [symbol] | y [symbol] | y [symbol] | . . . | y [symbol] | . . . | y [symbol] |
| | 2 | y [symbol] | y [symbol] | y [symbol] | . . . | y [symbol] | . . . | y [symbol] |
| | . . . | . . . | . . . | . . . | . . . | . . . | . . . | . . . |
| | i | y [symbol] | y [symbol] | y [symbol] | . . . | y [symbol] | . . . | y [symbol] |
| | . . . | . . . | . . . | . . . | . . . | . . . | . . . | . . . |
| | n | y [symbol] | y [symbol] | y [symbol] | . . . | y [symbol] | . . . | y [symbol] |

[symbol]

indicates data missing or illegible when filed

Further, the degradation model in this embodiment can be a model that can analyze the performance parameter values of the sample products when the stress is applied to estimate the lifetime even if the sample products have no failure data under the stress. The candidate degradation models are those used for stress accelerated tests. For example, typical degradation models include a degradation model 1 (1(x; a, b)=exp [−b*(x)\hat{ }a]), a degradation model 2 (1(x; a, b)=a*ln (x)+b]), and a degradation model 3 (1(x; a, b)=b*exp [a*x]).

Specifically, after obtaining the performance parameter values of the respective sample products under each group of the stress accelerated tests, each of the candidate degradation models can be used to analyze the obtained performance parameter values, and the optimal degradation model can be selected from the candidate degradation models according to the analysis results.

In step S302, failure times of the respective sample products under each group of the stress accelerated tests are determined based on the optimal degradation model.

Optionally, the failure time in this embodiment is the time from the start of the stress accelerated test to the failure of the sample product.

Specifically, preset failure thresholds of the respective sample products under each group of the stress accelerated tests are input into the optimal degradation model to obtain the failure times of the respective sample products under each group of the stress accelerated tests.

For example, assuming that a failure threshold of a sample product under a group of the stress accelerated tests is D, and taking the degradation model 2 as the optimal degradation model as an example for explanation. By replacing l(x; a, b) with D in the degradation model 2 l(x; a, b)=a*In (x)+b, the obtained x is the failure time t of this sample product under this group of the stress accelerated tests when the degradation model 2 is the optimal degradation model, as shown in formula (1):

$$T = exp ( \frac{D - b}{a} ) \qquad ( 1 )$$

Based on this, the failure times corresponding to the respective sample products under each group of the stress accelerated tests can be obtained, for example, as shown in Table 2 below.

TABLE 2
failure times corresponding to the respective sample products
under each group of the stress accelerated tests

| | Test | | |
|---|---|---|---|
| Accelerated | Product | Performance Parameter | Failure |
| Test | Number | Degradation Model | Time |
| First Group | 1 | Optimal Degradation | t₁₁ |
| | | Model l(x, a, b) | |
| | 2 | Optimal Degradation | t₁₂ |
| | | Model l(x, a, b) | |
| | . . . | . . . | . . . |
| | n | Optimal Degradation | t₁ [symbol] |
| | | Model l(x, a, b) | |
| Second Group | 1 | Optimal Degradation | t₂₁ |
| | | Model l(x, a, b) | |
| | 2 | Optimal Degradation | t₂₂ |
| | | Model l(x, a, b) | |
| | . . . | . . . | . . . |
| | n | Optimal Degradation | t₂ [symbol] |
| | | Model l(x, a, b) | |
| . . . | . . . | . . . | . . . |
| c-th Group | 1 | Optimal Degradation | t [symbol] ₁ |
| | | Model l(x, a, b) | |
| | 2 | Optimal Degradation | t [symbol] ₂ |
| | | Model l(x, a, b) | |
| | . . . | . . . | . . . |
| | n | Optimal Degradation | t [symbol] |
| | | Model l(x, a, b) | |

[symbol]

indicates data missing or illegible when filed

The unknown parameters a and b in the optimal degradation model can be obtained by using a maximum likelihood estimation method. For example, for the convenience of description, the degradation model 2 in S201 is used as an example to illustrate the solution process of the unknown parameters a and b.

For the i^{th} product of the k^{th} group, its maximum likelihood function is shown in formula (2):

$$L ( a , b ) = {\prod }_{i = 1}^{n} \frac{1}{\sqrt{2 π} v} \cdot {e}^{- \frac{{( {y}_{kid} - a \times ln {x}_{d} - b )}^{2}}{2 {v}^{2}}} \qquad ( 2 )$$

where v is the variance of all y_{kid}.

Then the system of likelihood equations is shown in formula (3):

$$\begin{matrix}\frac{\partial ln L}{\partial a} = 0 \\ \frac{\partial ln L}{\partial b} = 0\end{matrix} \qquad ( 3 )$$

By solving the above system of equations, the unknown parameters a and b are obtained.

It should be noted that the unknown parameters a and b can also be solved through the degradation models 1 and 3, and the process is similar to the process of solving the unknown parameters a and b through the degradation model 2, which will not be described again here.

In step S303, the optimal lifetime model is selected from candidate lifetime models based on the failure times of the respective sample products under each group of the stress accelerated tests.

Specifically, after obtaining the failure times of the respective sample products under each group of the stress accelerated tests, each of the candidate lifetime models can be used to analyze the obtained failure times, and the optimal lifetime model can be selected from the candidate lifetime models according to the analysis results.

In step S304, total sample characteristic lifetime corresponding to each group of the stress accelerated tests is determined based on the optimal lifetime model, and a stress condition corresponding to each group of the stress accelerated tests.

Specifically, after determining the optimal lifetime model, the stress condition corresponding to each group of the stress accelerated tests is input into the optimal lifetime model for calculation to obtain the total sample characteristic lifetime corresponding to each group of the stress accelerated tests. For example, assuming that the k^{th} group of accelerated tests has e types of stresses, namely Yₖ₁, Yₖ₂, ···, Yₖⱼ, ···, Yₖₑ, j=1, 2, ···, e, then the optimal lifetime model is shown in formula (4):

$${S}_{k} = exp [ {A}_{0} + {\sum }_{j = 1}^{e} ( {A}_{j} \times δ ( {Y}_{kj} ) ) ] \qquad ( 4 )$$

where A₀, A₁, A₂, ···, Aⱼ, ···, Aₑ are all unknown parameters, and δ(Yₖⱼ) is a function related to accelerated stress. Further, the stress conditions corresponding to several groups of the stress accelerated tests are substituted into formula (4) to obtain a system of equations, and the values of the unknown parameters A₀, A₁, A₂, ···, Aⱼ, ···, Aₑ can be obtained by solving the system of equations. If Yₖⱼ is a temperature stress, then δ(Yₖⱼ) is represented as follows:

$$δ ( {Y}_{kj} ) = \frac{1}{{T}_{kj}} ,$$

where Tₖⱼ is a temperature value of the j^{th} stress in the k^{th} group of accelerated tests. If Yₖⱼ is a humidity stress, then δ(Yₖⱼ) is represented as follows: δ(Yₖⱼ)=ln(RHₖⱼ), where RHₖⱼ is a humidity value of the j^{th} stress in the k^{th} group of accelerated tests. If Yₖⱼ is a voltage stress, then δ(Yₖⱼ) is represented as follows: δ(Yₖⱼ)=ln(Eₖⱼ), where Eₖⱼ is a voltage value of the j^{th} stress in the k^{th} group of accelerated tests. If Yₖⱼ is a vibration stress, then δ(Yₖⱼ) is represented as follows: δ(Yₖⱼ)=ln(Vₖⱼ), where Vₖⱼ is a vibration value of the j^{th} stress in the k^{th} group of accelerated tests.

It should be noted that the types of stresses in this embodiment can be set according to demands of the user, and the present disclosure does not limit the types of stresses. Furthermore, the stress condition corresponding to each group of the stress accelerated tests may include multiple stresses set by the user. By inputting the stress condition corresponding to each group of the stress accelerated tests into the determined optimal lifetime model, the total sample characteristic lifetime corresponding to each group of the stress accelerated tests can be determined.

In step S305, the correspondence relationships between the candidate stress conditions and the candidate characteristic lifetimes are established based on the total sample characteristic lifetime and the stress condition corresponding to each group of the stress accelerated tests.

Specifically, after obtaining the total sample characteristic lifetime and the stress condition corresponding to each group of the stress accelerated tests, the total sample characteristic lifetime under the respective groups of stress accelerated tests are used as the candidate characteristic lifetime, and the stress conditions corresponding to the respective groups of stress accelerated tests are used as the candidate stress conditions, and then the correspondence relationships between the candidate stress conditions and the candidate characteristic lifetimes can be established. For example, the established correspondence relationships between the candidate stress conditions and the candidate characteristic lifetimes are shown in Table 3 below.

TABLE 3
correspondence relationships between the candidate stress conditions and the
candidate characteristic lifetimes

| | | | Relationship between the |
|---|---|---|---|
| | | | candidate stress conditions |
| Accelerated | | Characteristic | and the candidate |
| test | Stress | lifetime | characteristic lifetimes |
| First group | Y₁₁, Y₁₂, ... , Y₁ⱼ, ... , Y₁ₑ | S₁ | ${S}_{1} = exp [ {A}_{0} + {\sum }_{j = 1}^{e} ( {A}_{j} \times δ ( {Y}_{1 j} ) ) ]$ |
| Second group | Y₂₁, Y₂₂, ... , Y₂ⱼ, ... , Y₂ₑ | S₂ | ${S}_{2} = exp [ {A}_{0} + {\sum }_{j = 1}^{e} ( {A}_{j} \times δ ( {Y}_{2 j} ) ) ]$ |
| ... | ... | ... | ... |
| K-th group | Yₖ₁, Yₖ₂, ... , Yₖⱼ, ... , Yₖₑ | Sₖ | ${S}_{k} = exp [ {A}_{0} + {\sum }_{j = 1}^{e} ( {A}_{j} \times δ ( {Y}_{kj} ) ) ]$ |
| ... | ... | ... | ... |
| c-th group | Y_{c1}, Y_{c2}, ... , Y_{cj}, ... , Y_{ce} | S_{c} | ${S}_{c} = exp [ {A}_{0} + {\sum }_{j = 1}^{e} ( {A}_{j} \times δ ( {Y}_{cj} ) ) ]$ |

It can be understood that in this embodiment, by introducing the optimal degradation model and the optimal lifetime model, the correspondence relationships between the candidate stress conditions and the candidate characteristic lifetimes can be finally established by using the total sample characteristic lifetimes and the stress conditions, thereby providing a basis for subsequent lifetime estimation.

On the basis of the above embodiments, the step of selecting the optimal degradation model from the candidate degradation models based on the performance parameter values of the respective sample products under each group of the stress accelerated tests will be described in detail. Optionally, as shown in FIG. 4, the step of selecting the optimal degradation model from the candidate degradation models based on the performance parameter values of the respective sample products under each group of the stress accelerated tests specifically includes the following steps.

In step S401, by using each of the candidate degradation models, a maximum likelihood analysis is performed on the performance parameter values of the respective sample products under each group of the stress accelerated tests to obtain maximum likelihood function values of the respective sample products under each of the candidate degradation models under each group of the stress accelerated tests.

Specifically, after solving the unknown parameters a and b of the respective candidate degradation models in step S302, the maximum likelihood function values L of the respective sample products under each of the candidate degradation models under each group of the stress accelerated tests can be obtained. For example, for the convenience of description, taking the unknown parameters a and b of the degradation model 2 (1(x; a, b)=a*ln(x)+b]) solved in above step S302 as an example, the solved unknown parameters a and b are substituted into the following formula (5), and then the maximum likelihood function values of the respective sample products under the degradation model 2 under each group of the stress accelerated tests can be obtained:

$$L ( a , b ) = {\prod }_{i = 1}^{n} \frac{1}{\sqrt{2 π v}} \cdot {e}^{- \frac{{( {y}_{kid} - a \times ln {x}_{d} - b )}^{2}}{2 {v}^{2}}} \qquad ( 5 )$$

It should be noted that the solution processes of the maximum likelihood function values of the respective sample products under the degradation model 1 and the degradation model 3 under each group of the stress accelerated tests are the same as the maximum likelihood function values of the respective sample products under the degradation model 2 under each group of the stress accelerated tests, and will not be repeated here.

Therefore, the maximum likelihood function values of the respective sample products under each of the candidate degradation models under each group of the stress accelerated tests are obtained, as shown in Table 4 below.

TABLE 4
maximum likelihood function values of the respective sample
products under each of the candidate degradation models
under each group of the stress accelerated tests

| | | Performance | Maximum |
|---|---|---|---|
| Accelerated | Test Product | Parameter | Likelihood |
| Test | Number | Degradation Model | Function Value |
| First group | 1 | Model 1 | L₁₁₁ |
| | | Model 2 | L₁₁₂ |
| | | Model 3 | L₁₁₃ |
| | 2 | Model 1 | L₁₂₁ |
| | | Model 2 | L₁₂₂ |
| | | Model 3 | L₁₂₃ |
| | . . . | . . . | . . . |
| | n | Model 1 | L₁ₙ₁ |
| | | Model 2 | L₁ₙ₂ |
| | | Model 3 | L₁ₙ₃ |
| Second group | 1 | Model 1 | L₂₁₁ |
| | | Model 2 | L₂₁₂ |
| | | Model 3 | L₂₁₃ |
| | 2 | Model 1 | L₂₂₁ |
| | | Model 2 | L₂₂₂ |
| | | Model 3 | L₂₂₃ |
| | . . . | . . . | . . . |
| | 3 | Model 1 | L₂ₙ₁ |
| | | Model 2 | L₂ₙ₂ |
| | | Model 3 | L₂ₙ₃ |
| . . . | . . . | . . . | . . . |
| c-th group | 1 | Model 1 | L_{c11} |
| | | Model 2 | L_{c12} |
| | | Model 3 | L_{c13} |
| | 2 | Model 1 | L_{c21} |
| | | Model 2 | L_{c22} |
| | | Model 3 | L_{c23} |
| | . . . | . . . | . . . |
| | n | Model 1 | L_{cn1} |
| | | Model 2 | L_{cn2} |
| | | Model 3 | L_{cn3} |

In step S402, the optimal degradation model is selected from the candidate degradation models based on a sum of the maximum likelihood function values of the respective sample products under each of the candidate degradation models under each group of the stress accelerated tests.

Specifically, after obtaining the maximum likelihood function values of the respective sample products under each of the candidate degradation models under each group of the stress accelerated tests, for each of the candidate degradation models, the maximum likelihood function values of the respective sample products under this candidate degradation model under each group of the stress accelerated tests are summed to obtain a first total likelihood value corresponding to this candidate degradation model, and then the candidate degradation model corresponding to the largest first total likelihood value is used as the optimal degradation model.

It can be understood that in this embodiment, by introducing the maximum likelihood function and the performance parameter values, the maximum likelihood function can be used to analyze the performance parameter values, thereby obtaining the optimal degradation model, providing an implementable method for obtaining the optimal degradation model.

On the basis of the above embodiment, the step of selecting the optimal lifetime model from the candidate lifetime models based on the failure times of the respective sample products under each group of the stress accelerated tests will be described in detail. Optionally, as shown in FIG. 5, the step of selecting the optimal lifetime model from the candidate lifetime models based on the failure times of the respective sample products under each group of the stress accelerated tests specifically includes the following steps.

In step S501, by using each of the candidate lifetime models, a maximum likelihood analysis is performed on the failure times of the respective sample products under each group of the stress accelerated tests to obtain maximum likelihood function values of the respective sample products under each of the candidate lifetime models under each group of the stress accelerated tests.

Optionally, typical product performance parameter lifetime models include a scale parameter function model

$$( {F}_{k} ( t ) = G ( \frac{t}{{σ}_{k}} ) ) ,$$

a location-scale parameter function model

$$( {F}_{k} ( t ) = G ( \frac{t - {μ}_{k}}{{σ}_{k}} ) ) ,$$

and a log-location and scale parameter function model

$$( {F}_{k} ( t ) = G ( \frac{ln t - {μ}_{k}}{{σ}_{k}} ) ) .$$

For the convenience of description, take the candidate lifetime model as the log-location and scale parameter function model as an example for illustration. Assuming that the failure times of the respective sample products follows a lognormal distribution, its density function is shown in the following formula (6):

$${f}_{k} ( t ) = \frac{1}{\sqrt{2 π} {σ}_{k} t} {e}^{- \frac{{( ln t - {μ}_{k} )}^{2}}{2 {{σ}_{k}}^{2}}} , t > 0 \qquad ( 6 )$$

Then the likelihood function under the log-location and scale parameter function model is shown in the following formula (7):

$$L ( {μ}_{k} , {σ}_{k} ) = \frac{n !}{( n - r ) !} {( \frac{1}{\sqrt{2 π} {σ}_{k}} )}^{r} {\prod }_{i = 1}^{r} \frac{1}{{t}_{( i )}} {e}^{- \{ \frac{1}{2 {σ}_{k}^{2}} ln {t}_{ki - {μ}_{k}^{2}} \}} . {[ 1 - Φ ( \frac{ln {t}_{kn} - {μ}_{k}}{{σ}_{k}} ) ]}^{n - r} \qquad ( 7 )$$

where r is the number of failed products.

By taking the partial derivative of the likelihood function under this log-location and scale parameter function model, a system of likelihood equations can be obtained, as shown in the following formula (8):

$$\frac{\partial ln L}{\partial {μ}_{k}} = \frac{1}{{σ}_{k}^{2}} {\sum }_{i = 1}^{r} ( ln {t}_{ki} - {μ}_{k} ) + \frac{n - r}{{σ}_{k}} \frac{∅ ( ( ln {t}_{kn} - {μ}_{k} ) / {σ}_{k} )}{Φ ( - ( ln {t}_{kn} - {μ}_{k} ) / {σ}_{k} )} = 0 ↵ \qquad ( 8 )$$

$$\frac{\partial ln L}{\partial {σ}_{k}} = - \frac{r}{{σ}_{k}^{2}} + \frac{1}{{σ}_{k}^{3}} {\sum }_{i = 1}^{r} {( ln {t}_{ki} - {μ}_{k} )}^{2} + ( n - r ) \frac{∅ ( ( ln {t}_{kn} - {μ}_{k} ) / {σ}_{k} )}{Φ ( - ( ln {t}_{kn} - {μ}_{k} ) / {σ}_{k} )} \cdot \frac{ln {t}_{kn} - {μ}_{k}}{{σ}_{k}^{2}} = 0 ↵$$

By solving the above system of equations, the unknown parameters σₖ and μₖ can be obtained.

By substituting the obtained unknown parameters σₖ and μₖ into the above formula (7), the maximum likelihood function values of the respective sample products under the log-location and scale parameter function model under each group of the stress accelerated tests can be obtained.

It should be noted that the solution process of the maximum likelihood function values of the respective sample products under the scale parameter function model and the location-scale parameter function model under each group of the stress accelerated tests is the same as the solution process of the maximum likelihood function values of the respective sample products under the log-location and scale parameter function model under each group of the stress accelerated tests, and will not be repeated here.

Optionally, the maximum likelihood function values of the respective sample products under the scale parameter function model, the location-scale parameter function model, the log-location and scale parameter function model under each group of the stress accelerated tests are as shown in Table 5 below.

TABLE 5
maximum likelihood function values of the respective sample products
under the scale parameter function model, the location-scale parameter
function model, the log-location and scale parameter function model
under each group of the stress accelerated tests

| Accelerated | Performance parameter | Maximum likelihood |
|---|---|---|
| test | lifetime model | Function value |
| First group | Scale parameter function model | L′₁₁ |
| | Location-scale parameter | L′₁₂ |
| | function model | |
| | Log-location and scale | L′₁ₙ |
| | parameter function model | |
| Second group | Scale parameter function model | L′₂₁ |
| | Location-scale parameter | L′₂₂ |
| | function model | |
| | Log-location and scale | L′₂ₙ |
| | parameter function model | |
| . . . | . . . | . . . |
| c-th group | Scale parameter function model | L′_{c1} |
| | Location-scale parameter | L′_{c2} |
| | function model | |
| | Log-location and scale | L′_{cn} |
| | parameter function model | |

In step S502, the optimal lifetime model is selected from the candidate lifetime models based on a sum of the maximum likelihood function values of the respective sample products under each of the candidate lifetime models under each group of the stress accelerated tests.

Specifically, after obtaining the maximum likelihood function values of the respective sample products under each of the candidate lifetime models under each group of the stress accelerated tests, for each of the candidate lifetime models, the maximum likelihood function values of the respective sample products under this candidate lifetime model under each group of the stress accelerated tests are summed to obtain a second total likelihood value corresponding to this candidate lifetime model, and then the candidate lifetime model corresponding to the largest second total likelihood value is used as the optimal lifetime model.

It can be understood that in this embodiment, by introducing the maximum likelihood function and the failure times, the maximum likelihood function can be used to analyze the failure times, thereby obtaining the optimal lifetime model, providing an implementable method for obtaining the optimal lifetime model.

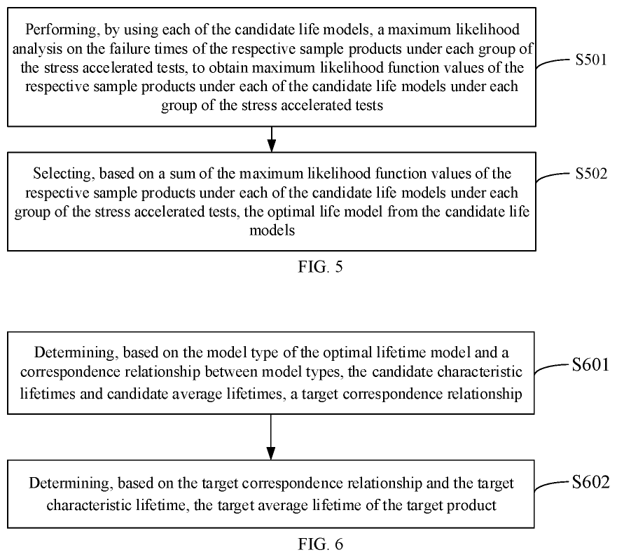

On the basis of the above embodiment, the step of determining the target average lifetime of the target product based on the optimal lifetime model for the type to which the target product belongs and the target characteristic lifetime will be described in detail. Optionally, as shown in FIG. 6, the step of determining the target average lifetime of the target product based on the optimal lifetime model for the type to which the target product belongs and the target characteristic lifetime specifically includes the following steps.

In step S601, a target correspondence relationship is determined based on the model type of the optimal lifetime model and a correspondence relationship between model types, the candidate characteristic lifetimes and candidate average lifetimes.

Specifically, after selecting the optimal lifetime model from the candidate lifetime models in step S502, the model type of the optimal lifetime model is determined. Then, based on the model type of the optimal lifetime model, and according to the following Table 6 (still take the candidate lifetime models including the scale parameter function model, the location-scale parameter function model, and the log-location and scale parameter function model as an example for illustration), the correspondence relationship that matches the model type of the optimal lifetime model is selected from the correspondence relationships between the candidate characteristic lifetimes and the candidate average lifetimes, and is used as the target correspondence relationship.

TABLE 6
correspondence relationships between the candidate characteristic lifetimes
and the candidate average lifetimes

| | Candidate | |
|---|---|---|
| | Characteristic | |
| Model Name | Lifetime | Candidate Average Lifetime |
| Scale Parameter | S₀ | For an exponential distribution |
| Function Model | | function, the average lifetime is S₀ |
| Location-Scale | S₁ | For a normal distribution function, |
| Parameter Function | | the average lifetime is S₁; |
| Model | | For a dual-parameter exponential |
| | | distribution, the average lifetime is |
| | | S₁ + σₖ |
| Log-Location and | S₂ | For a lognormal distribution, the |
| Scale Parameter Function Model | | $average lifetime is exp ( {S}_{2} + \frac{{σ}_{k}^{2}}{2} )$ |

In step S602, the target average lifetime of the target product is determined based on the target correspondence relationship and the target characteristic lifetime.

Specifically, after obtaining the target correspondence relationship, combined with the target characteristic lifetime obtained in step S201, the target average lifetime of the target product can be determined based on the above Table. For example, if the model type of the optimal lifetime model is the log-location and scale parameter function model, the target characteristic lifetime is S2, and the function distribution under the log-location and scale parameter function model is a lognormal distribution, then the target average lifetime of the target product is determined as follows:

$$exp ( {S}_{2} + \frac{{σ}_{K}^{2}}{2} ) .$$

It can be understood that in this embodiment, by introducing the correspondence relationship between the types of the optimal lifetime model, the candidate characteristic lifetimes and candidate average lifetimes, the target average lifetime of the target product can be determined by using the correspondence relationship between types of the optimal lifetime model, the candidate characteristic lifetime and candidate average lifetime.

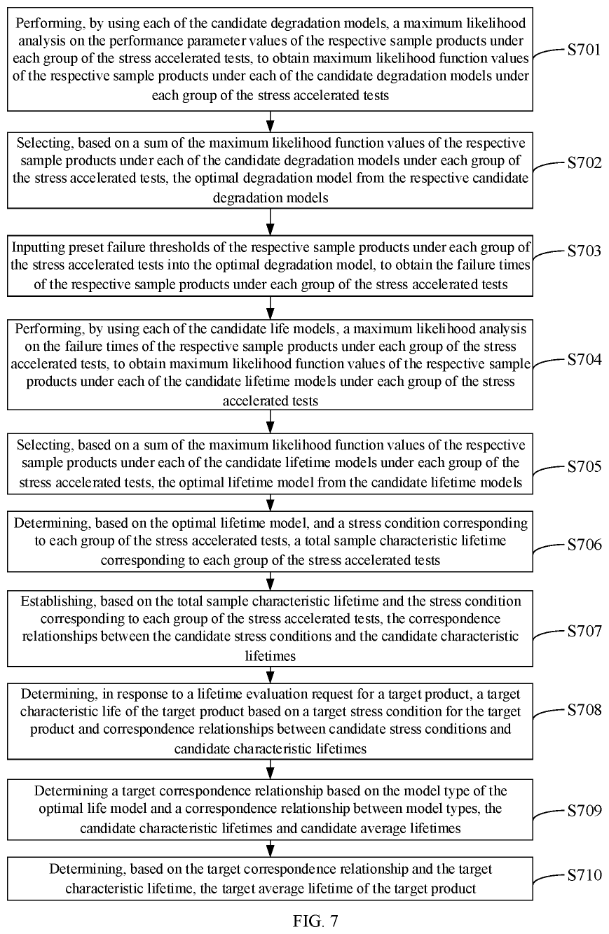

In addition, the present disclosure further provides an optional embodiment of a method for estimating product lifetime based on a multi-stress accelerated test. FIG. 7 is a schematic flow chart of a method for estimating product lifetime based on a multi-stress accelerated test in another embodiment. As shown in FIG. 7, the method specifically includes the following steps.

In step S701, by using each of the candidate degradation models, a maximum likelihood analysis is performed on the performance parameter values of the respective sample products under each group of the stress accelerated tests to obtain maximum likelihood function values of the respective sample products under each of the candidate degradation models under each group of the stress accelerated tests.

In step S702, the optimal degradation model is selected from the candidate degradation models based on a sum of the maximum likelihood function values of the respective sample products under each of the candidate degradation models under each group of the stress accelerated tests.

In step S703, preset failure thresholds of the respective sample products under each group of the stress accelerated tests are input into the optimal degradation model to obtain the failure times of the respective sample products under each group of the stress accelerated tests.

In step S704, by using each of the candidate lifetime models, a maximum likelihood analysis is performed on the failure times of the respective sample products under each group of the stress accelerated tests to obtain maximum likelihood function values of the respective sample products under each of the candidate lifetime models under each group of the stress accelerated tests.

In step S705, the optimal lifetime model is selected from the candidate lifetime models based on a sum of the maximum likelihood function values of the respective sample products under each of the candidate lifetime models under each group of the stress accelerated tests.

In step S706, a total sample characteristic lifetime corresponding to each group of the stress accelerated tests is determined based on the optimal lifetime model and a stress condition corresponding to each group of the stress accelerated tests.

In step S707, the correspondence relationships between the candidate stress conditions and the candidate characteristic lifetimes are established based on the total sample characteristic lifetime and the stress condition corresponding to each group of the stress accelerated tests.

In step S708, in response to a lifetime estimation request for a target product, a target characteristic lifetime of the target product is determined based on a target stress condition for the target product and the correspondence relationships between the candidate stress conditions and the candidate characteristic lifetimes.

In step S709, a target correspondence relationship is determined based on the model type of the optimal lifetime model and a correspondence relationship between model types, the candidate characteristic lifetimes and candidate average lifetimes.

In step S710, the target average lifetime of the target product is determined based on the target correspondence relationship and the target characteristic lifetime.

The specific process of the above steps S701-S710 can be referred to in the description of the above method embodiments, the implementation principles and technical effects are similar and will not be described again here.

It should be understood that although the individual steps in the flow diagrams involved of the embodiments as described above are shown sequentially as indicated by arrows, the steps are not necessarily performed sequentially in the order indicated by the arrows. Unless explicitly stated herein, the execution of these steps is not strictly limited in order and these steps can be performed in any other order. Moreover, at least some of the steps in the flow diagrams involved of the embodiments as described above may include a plurality of steps or a plurality of stages that are not necessarily performed at the same time, but may be performed at different times. The order in which these steps or stages are performed is not necessarily sequential, and these steps may be performed alternately or alternately with other steps or at least some of the steps or stages in other steps.

Based on the same inventive concept, embodiments of the present disclosure also provide an apparatus for estimating product lifetime based on a multi-stress accelerated test for implementing the method for estimating product lifetime based on a multi-stress accelerated test as described above. The solution to the problem provided by the apparatus is similar to the implementation of the method documented above, so the specific features in the one or more embodiments of the apparatus for estimating product lifetime based on a multi-stress accelerated test provided below may be understood with reference to the features of the above method for estimating product lifetime based on a multi-stress accelerated test and will not be repeated here.

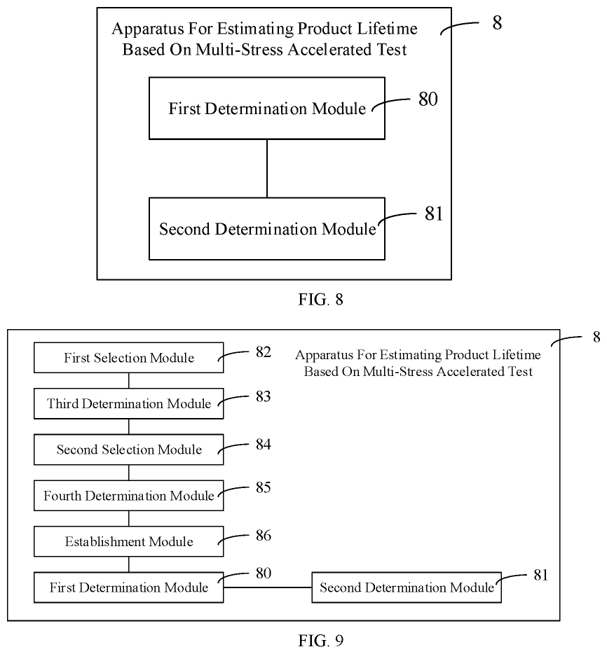

In an embodiment, FIG. 8 is a block diagram illustrating a configuration of an apparatus for estimating product lifetime based on a multi-stress accelerated test. As shown in FIG. 8, an apparatus 8 for estimating product lifetime based on a multi-stress accelerated test is provided. This apparatus includes a first determination module 80 and a second determination module 81.

The first determination module 80 is configured to determine, in response to a lifetime estimation request for a target product, a target characteristic lifetime of the target product based on a target stress condition for the target product and correspondence relationships between candidate stress conditions and candidate characteristic lifetimes.

The correspondence relationships between the candidate stress conditions and the candidate characteristic lifetimes are obtained by processing performance parameter values of respective sample products under different groups of stress accelerated tests. The sample product is of the same type as the target product, and each of the candidate stress conditions includes at least two types of stresses.

The second determination module 81 is configured to determine a target average lifetime of the target product based on an optimal lifetime model for the type to which the target product belongs and the target characteristic lifetime.

In the above apparatus for estimating product lifetime based on a multi-stress accelerated test, in response to the lifetime estimation request for the target product, the target characteristic lifetime of the target product is determined according to the target stress condition of the target product based on the correspondence relationships between the candidate stress conditions and the candidate characteristic lifetimes. Then, based on the optimal lifetime model for the type to which the target product belongs, the target average lifetime of the target product can be determined. Compared with the method for estimating product lifetime based on a multi-stress accelerated test in the related art, this disclosure can realize the lifetime estimation request for any stress condition of the target product by establishing the correspondence relationships between the candidate stress conditions and the candidate characteristic lifetimes, solving the problem that the product lifetime estimation can only be performed based on a dual-stress accelerated test in the related art, expanding the stress conditions for estimating the lifetime of the target product, and meeting the lifetime estimation request for the product based on the accelerated test under the combined effects of multiple stresses.

In an embodiment, FIG. 9 is a block diagram illustrating a configuration of an apparatus for estimating product lifetime based on a multi-stress accelerated test in another embodiment. As shown in FIG. 9, the apparatus for estimating product lifetime based on a multi-stress accelerated test further includes a first selection module 82, a third determination module 83, a second selection module 84, a fourth determination module 85, and an establishment module 86.

The first selection module 82 is configured to select, based on the performance parameter values of the respective sample products under each group of the stress accelerated tests, an optimal degradation model from candidate degradation models.

The third determination module 83 is configured to determine, based on the optimal degradation model, failure times of the respective sample products under each group of the stress accelerated tests.

The second selection module 84 is configured to select, based on the failure times of the respective sample products under each group of the stress accelerated tests, the optimal lifetime model from candidate lifetime models.

The fourth determination module 85 is configured to determine, based on the optimal lifetime model and a stress condition corresponding to each group of the stress accelerated tests, a total sample characteristic lifetime corresponding to each group of the stress accelerated tests.

The establishment module 86 is configured to establish, based on the total sample characteristic lifetime and the stress condition corresponding to each group of the stress accelerated tests, the correspondence relationships between the candidate stress conditions and the candidate characteristic lifetime.

In an embodiment, the first selection module 82 is specifically configured to: perform, by using each of the candidate degradation models, a maximum likelihood analysis on the performance parameter values of the respective sample products under each group of the stress accelerated tests, to obtain maximum likelihood function values of the respective sample products under each of the candidate degradation models under each group of the stress accelerated tests; and select, based on a sum of the maximum likelihood function values of the respective sample products under each of the candidate degradation models under each group of the stress accelerated tests, the optimal degradation model from the respective candidate degradation models.

In an embodiment, the third determination module 83 is specifically configured to input preset failure thresholds of the respective sample products under each group of the stress accelerated tests into the optimal degradation model to obtain the failure times of the respective sample products under each group of the stress accelerated tests.

In an embodiment, the second selection module 84 is specifically configured to: perform, by using each of the candidate lifetime models, a maximum likelihood analysis on the failure times of the respective sample products under each group of the stress accelerated tests, to obtain maximum likelihood function values of the respective sample products under each of the candidate lifetime models under each group of the stress accelerated tests; and select, based on a sum of the maximum likelihood function values of the respective sample products under each of the candidate lifetime models under each group of the stress accelerated tests, the optimal lifetime model from the candidate lifetime models.

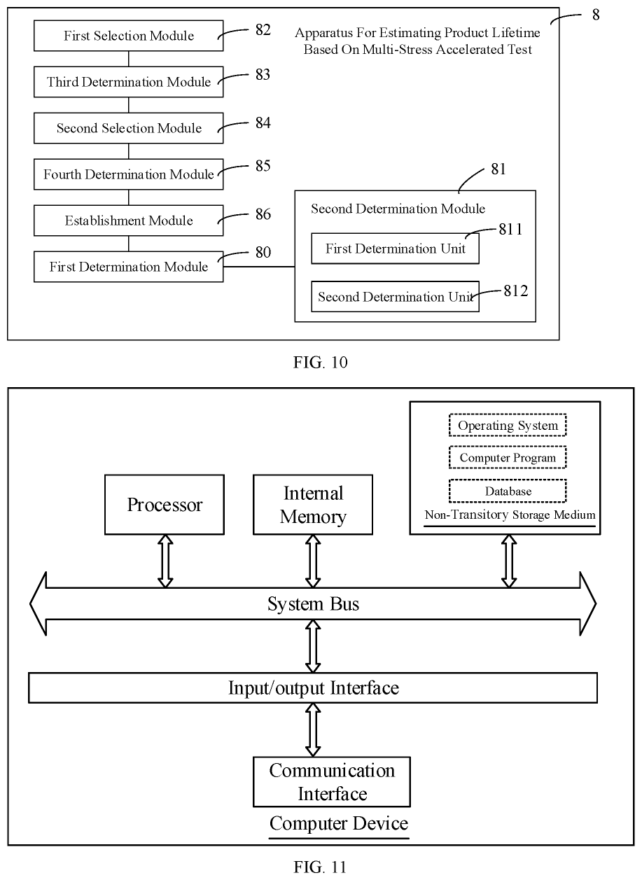

In an embodiment, FIG. 10 is a block diagram illustrating a configuration of an apparatus for estimating product lifetime based on a multi-stress accelerated test in another embodiment. As shown in FIG. 10, the second determination module 81 in FIG. 8 above may specifically include a first determination unit 811 and a second determination unit 812.

The first determination unit 811 is configured to determine a target correspondence relationship based on the model type of the optimal lifetime model and a correspondence relationship between model types, the candidate characteristic lifetimes and the candidate average lifetimes.

The second determination unit 812 is configured to determine, based on the target correspondence relationship and the target characteristic lifetime, the target average lifetime of the target product.

The individual modules in the above apparatus for estimating product lifetime based on a multi-stress accelerated test can be implemented in whole or in part by software, hardware and combinations thereof. Each of the above modules may be embedded in hardware form or independent of a processor in a computer device, or may be stored in software form on a memory in the computer device so that the processor can be called to perform the operations corresponding to each of the above modules.

In an embodiment, a computer device is provided, which may be a server. A diagram illustrating an internal configuration of the computer device may be shown in FIG. 11. The computer device includes a processor, a memory, and a network interface connected via a system bus. The processor of the computer device is configured to provide computing and control capabilities. The memory of the computer device includes a non-transitory storage medium and an internal memory. The non-transitory storage medium stores operating systems, computer programs and databases. The internal memory provides an environment for the operation of operating systems and computer programs in non-transitory storage medium. The database of the computer device is configured to store product lifetime estimation data based on a multi-stress accelerated test. The network interface of the computer device is configured to communicate with external terminals through a network connection. The computer programs, when executed by the processor, implement a method for estimating product lifetime based on a multi-stress accelerated test.

It should be understood by those skilled in the art that the configuration illustrated in FIG. 11, which is only a block diagram of part of the configuration related to the solution of the present disclosure, and does not constitute a limitation on the computer device to which the solution of the present disclosure is applied. Specifically, the computer device may include more or less components than those shown in the figure, or may combine some components, or may have a different arrangement of components.

In an embodiment, a computer device is provided, including a processor and a memory storing computer programs. The computer programs, when executed by the processor, implement the following steps:
determining, in response to a lifetime estimation request for a target product, a target characteristic lifetime of the target product based on a target stress condition for the target product and correspondence relationships between candidate stress conditions and candidate characteristic lifetimes, the correspondence relationships between the candidate stress conditions and the candidate characteristic lifetimes being obtained by processing performance parameter values of respective sample products under different groups of stress accelerated tests, the sample product being of the same type as the target product, and each of the candidate stress conditions includes at least two types of stresses; and
determining, based on an optimal lifetime model for the type to which the target product belongs and the target characteristic lifetime, a target average life of the target product.

In an embodiment, the processor, when executing the logic in the computer programs to process the performance parameter values of the respective sample products under different groups of the stress accelerated tests, specifically implements the following steps:
selecting, based on the performance parameter values of the respective sample products under each group of the stress accelerated tests, an optimal degradation model from candidate degradation models; determining, based on the optimal degradation model, failure times of the respective sample products under each group of the stress accelerated tests; selecting, based on the failure times of the respective sample products under each group of the stress accelerated tests, the optimal lifetime model from candidate lifetime models; determining, based on the optimal lifetime model and a stress condition corresponding to each group of the stress accelerated tests, a total sample characteristic lifetime corresponding to each group of the stress accelerated tests; and establishing, based on the total sample characteristic lifetime and the stress condition corresponding to each group of the stress accelerated tests, the correspondence relationships between the candidate stress conditions and the candidate characteristic lifetimes.

In an embodiment, the processor, when executing the logic in the computer programs to select the optimal degradation model from the candidate degradation models based on the performance parameter values of the respective sample products under each group of the stress accelerated tests, specifically implements the following steps:
performing, by using each of the candidate degradation models, a maximum likelihood analysis on the performance parameter values of the respective sample products under each group of the stress accelerated tests, to obtain maximum likelihood function values of the respective sample products under each of the candidate degradation models under each group of the stress accelerated tests; and selecting, based on a sum of the maximum likelihood function values of the respective sample products under each of the candidate degradation models under each group of the stress accelerated tests, the optimal degradation model from the respective candidate degradation models.

In an embodiment, the processor, when executing the logic in the computer programs to determine the failure times of the respective sample products under each group of the stress accelerated tests based on the optimal degradation model, specifically implements the following steps:
inputting preset failure thresholds of the respective sample products under each group of the stress accelerated tests into the optimal degradation model to obtain the failure times of the respective sample products under each group of the stress accelerated tests.

In an embodiment, the processor, when executing the logic in the computer programs to select the optimal lifetime model from the candidate lifetime models based on the failure times of the respective sample products under each group of the stress accelerated tests, specifically implements the following steps:
performing, by using each of the candidate lifetime models, a maximum likelihood analysis on the failure times of the respective sample products under each group of the stress accelerated tests, to obtain maximum likelihood function values of the respective sample products under each of the candidate lifetime models under each group of the stress accelerated tests; and selecting, based on a sum of the maximum likelihood function values of the respective sample products under each of the candidate lifetime models under each group of the stress accelerated tests, the optimal lifetime model from the candidate lifetime models.

In an embodiment, the processor, when executing the logic in the computer programs to determine the target average lifetime of the target product based on the optimal lifetime model for the type to which the target product belongs and the target characteristic lifetime, specifically implements the following steps:
determining a target correspondence relationship, based on the model type of the optimal lifetime model and a correspondence relationship between model types, the candidate characteristic lifetimes, and candidate average lifetimes; and determining, based on the target correspondence relationship and the target characteristic lifetime, the target average lifetime of the target product.

The principles and specific processes of the respective embodiments, when implemented by the computer device provided above, can be referred to in the description of the method for estimating product lifetime based on a multi-stress accelerated test in the above method embodiments, and will not be described again here.

In an embodiment, a computer-readable storage medium is provided, having computer programs stored therein. The computer programs, when executed by a processor, implement the following steps:
determining, in response to a lifetime estimation request for a target product, a target characteristic lifetime of the target product based on a target stress condition for the target product and correspondence relationships between candidate stress conditions and candidate characteristic lifetimes, the correspondence relationships between the candidate stress conditions and the candidate characteristic lifetimes being obtained by processing performance parameter values of respective sample products under different groups of stress accelerated tests, the sample product being of the same type as the target product, and each of the candidate stress conditions includes at least two types of stresses; and
determining, based on an optimal lifetime model for the type to which the target product belongs and the target characteristic lifetime, a target average lifetime of the target product.

In an embodiment, the computer programs, when it is detected that the logic for processing the performance parameter values of the respective sample products under different groups of the stress accelerated tests is executed by the processor, specifically implement the following steps:
selecting, based on the performance parameter values of the respective sample products under each group of the stress accelerated tests, an optimal degradation model from candidate degradation models; determining, based on the optimal degradation model, failure times of the respective sample products under each group of the stress accelerated tests; selecting, based on the failure times of the respective sample products under each group of the stress accelerated tests, the optimal lifetime model from candidate lifetime models; determining, based on the optimal lifetime model and a stress condition corresponding to each group of the stress accelerated tests, a total sample characteristic lifetime corresponding to each group of the stress accelerated tests; and establishing, based on the total sample characteristic lifetime and the stress condition corresponding to each group of the stress accelerated tests, the correspondence relationships between the candidate stress conditions and the candidate characteristic lifetimes.

In an embodiment, the computer programs, when the logic for selecting the optimal degradation model from the candidate degradation models based on the performance parameter values of the respective sample products under each group of the stress accelerated tests is executed by the processor, specifically implement the following steps:
performing, by using each of the candidate degradation models, a maximum likelihood analysis on the performance parameter values of the respective sample products under each group of the stress accelerated tests, to obtain maximum likelihood function values of the respective sample products under each of the candidate degradation models under each group of the stress accelerated tests; and selecting, based on a sum of the maximum likelihood function values of the respective sample products under each of the candidate degradation models under each group of the stress accelerated tests, the optimal degradation model from the respective candidate degradation models.

In an embodiment, the computer programs, when the logic for determining the failure times of the respective sample products under each group of the stress accelerated tests based on the optimal degradation model is executed by the processor, specifically implement the following steps:
inputting preset failure thresholds of the respective sample products under each group of the stress accelerated tests into the optimal degradation model, to obtain the failure times of the respective sample products under each group of the stress accelerated tests.

In an embodiment, the computer programs, when the logic for selecting the optimal lifetime model from the candidate lifetime models based on the failure times of the respective sample products under each group of the stress accelerated tests is executed by the processor, specifically implement the following steps:
performing, by using each of the candidate lifetime models, a maximum likelihood analysis on the failure times of the respective sample products under each group of the stress accelerated tests, to obtain maximum likelihood function values of the respective sample products under each of the candidate lifetime models under each group of the stress accelerated tests; and selecting, based on a sum of the maximum likelihood function values of the respective sample products under each of the candidate lifetime models under each group of the stress accelerated tests, the optimal lifetime model from the candidate lifetime models.

In an embodiment, the computer programs, when the logic for determining the target average lifetime of the target product based on the optimal lifetime model for the type to which the target product belongs and the target characteristic lifetime is executed by the processor, specifically implement the following steps:
determining, based on the model type of the optimal lifetime model and a correspondence relationship between model types, the candidate characteristic lifetime and candidate average lifetime, a target correspondence relationship; and determining, based on the target correspondence relationship and the target characteristic lifetime, the target average lifetime of the target product.

The principles and specific processes of the respective embodiments, when implemented by the computer-readable storage medium provided above, can be referred to in the description of the method for estimating product lifetime based on a multi-stress accelerated test in the above method embodiments, and will not be described again here.

In an embodiment, a computer program product is provided, including computer programs. The computer programs, when executed by a processor, implement the following steps:
determining, in response to a lifetime estimation request for a target product, a target characteristic lifetime of the target product based on a target stress condition for the target product and correspondence relationships between candidate stress conditions and candidate characteristic lifetimes, the correspondence relationships between the candidate stress conditions and the candidate characteristic lifetimes being obtained by processing performance parameter values of respective sample products under different groups of stress accelerated tests, the sample product being of the same type as the target product, and each of the candidate stress conditions includes at least two types of stresses; and
determining, based on an optimal lifetime model for the type to which the target product belongs and the target characteristic lifetime, a target average lifetime of the target product.

In an embodiment, the computer programs, when it is detected that the logic for processing the performance parameter values of the respective sample products under different groups of the stress accelerated tests is executed by the processor, specifically implement the following steps:
selecting, based on the performance parameter values of the respective sample products under each group of the stress accelerated tests, an optimal degradation model from candidate degradation models; determining, based on the optimal degradation model, failure times of the respective sample products under each group of the stress accelerated tests; selecting, based on the failure times of the respective sample products under each group of the stress accelerated tests, the optimal lifetime model from candidate lifetime models; determining, based on the optimal lifetime model, and a stress condition corresponding to each group of the stress accelerated tests, a total sample characteristic lifetime corresponding to each group of the stress accelerated tests; and establishing, based on the total sample characteristic lifetime and the stress condition corresponding to each group of the stress accelerated tests, the correspondence relationships between the candidate stress conditions and the candidate characteristic lifetimes.

In an embodiment, the computer programs, when the logic for selecting the optimal degradation model from the candidate degradation models based on the performance parameter values of the respective sample products under each group of the stress accelerated tests is executed by the processor, specifically implement the following steps:
performing, by using each of the candidate degradation models, a maximum likelihood analysis on the performance parameter values of the respective sample products under each group of the stress accelerated tests, to obtain maximum likelihood function values of the respective sample products under each of the candidate degradation models under each group of the stress accelerated tests; and selecting, based on a sum of the maximum likelihood function values of the respective sample products under each of the candidate degradation models under each group of the stress accelerated tests, the optimal degradation model from the respective candidate degradation models.

In an embodiment, the computer programs, when the logic for determining the failure times of the respective sample products under each group of the stress accelerated tests based on the optimal degradation model is executed by the processor, specifically implement the following steps:
inputting preset failure thresholds of the respective sample products under each group of the stress accelerated tests into the optimal degradation model, to obtain the failure times of the respective sample products under each group of the stress accelerated tests.

In an embodiment, the computer programs, when the logic for selecting the optimal lifetime model from the candidate lifetime models based on the failure times of the respective sample products under each group of the stress accelerated tests is executed by the processor, specifically implement the following steps:
performing, by using each of the candidate lifetime models, a maximum likelihood analysis on the failure times of the respective sample products under each group of the stress accelerated tests, to obtain maximum likelihood function values of the respective sample products under each of the candidate lifetime models under each group of the stress accelerated tests; and selecting, based on a sum of the maximum likelihood function values of the respective sample products under each of the candidate lifetime models under each group of the stress accelerated tests, the optimal lifetime model from the candidate lifetime models.

In an embodiment, the computer programs, when the logic for determining the target average lifetime of the target product based on the optimal lifetime model for the type to which the target product belongs and the target characteristic lifetime is executed by the processor, specifically implement the following steps:
determining a target correspondence relationship based on the model type of the optimal lifetime model and a correspondence relationship between model types, the candidate characteristic lifetimes and candidate average lifetimes; and determining, based on the target correspondence relationship and the target characteristic lifetime, the target average lifetime of the target product.

The principles and specific processes of the respective embodiments, when implemented by the computer program product provided above, can refer to the description of the method for estimating product lifetime based on a multi-stress accelerated test in the above method embodiments, and will not be described again here.

A person of ordinary skill in the art may understand that implementation of all or part of the processes in the methods of the above embodiments may be completed by instructing the relevant hardware through a computer program. The computer program may be stored in a non-transitory computer-readable storage medium. When the computer program is executed, it may include the processes of the embodiments of the above methods. Any reference to memory, database or other medium used of the embodiments provided in the present disclosure may include at least one of a non-transitory and a transitory memory. The non-transitory memory may include a read-only memory (ROM), a magnetic tape, a floppy disk, a flash memory, an optical memory, a high-density embedded non-transitory memory, a resistive random-access memory (ReRAM), a magneto resistive random-access memory (MRAM), a ferroelectric random-access memory (FRAM), a phase change memory (PCM), or a graphene memory, etc. The transitory memory may include a random-access memory (RAM) or an external cache memory, etc. As an illustration rather than a limitation, the random-access memory may be in various forms, such as a static random-access memory (SRAM) or a dynamic random-access memory (DRAM), etc. The databases involved of the embodiments provided by the present disclosure may include at least one of a relational database and a non-relational database. The non-relational database may include, but is not limited to, a blockchain-based distributed database, etc. The processor involved of the embodiments provided by the present disclosure may be, but is not limited to, a general purpose processor, a central processor, a graphics processor, a digital signal processor, a programmable logic device, a data processing logic device based on quantum computation, and the like.

The technical features in the above embodiments may be combined arbitrarily. For concise description, not all possible combinations of the technical features in the above embodiments are described. However, provided that they do not conflict with each other, all combinations of the technical features are to be considered to be within the scope described in this specification.

The above-mentioned embodiments only describe several implementations of the present disclosure, and their description is specific and detailed, but should not be understood as a limitation on the patent scope of the present disclosure. It should be noted that, for a person of ordinary skill in the art may further make variations and improvements without departing from the conception of the present disclosure, and these all fall within the protection scope of the present disclosure. Therefore, the protection scope of the present disclosure should be subject to the appended claims.

1. A method for estimating product lifetime based on a multi-stress accelerated test, the method being applied to an electronic device, the electronic device storing multiple candidate degradation models and multiple candidate lifetime models, the method comprising:
determining, in response to a lifetime estimation request for a target product, a target characteristic lifetime of the target product based on a target stress condition for the target product and correspondence relationships between candidate stress conditions and candidate characteristic lifetimes, wherein the correspondence relationships between the candidate stress conditions and the candidate characteristic lifetimes are obtained by processing performance parameter values of respective sample products under different groups of stress accelerated tests, the sample product is of the same type as the target product, and each of the candidate stress conditions comprises at least two types of stresses; and
determining, based on an optimal lifetime model for the type to which the target product belongs and the target characteristic lifetime, a target average lifetime of the target product;
wherein processing the performance parameter values of the respective sample products under different groups of the stress accelerated tests comprises:
performing multiple groups of stress accelerated tests to multiple sample products to obtain the performance parameter values of the respective sample products under each group of the stress accelerated tests;
analyzing the performance parameter values of the respective sample products under each group of the stress accelerated tests using the candidate degradation models stored in the electronic device to obtain analyzing results, and selecting an optimal degradation model from candidate degradation models based on the analyzing results;
inputting preset failure thresholds of the respective sample products under each group of the stress accelerated tests into the optimal degradation model to obtain failure times of the respective sample products under each group of the stress accelerated tests, wherein the failure time is a time from the start of the stress accelerated test to the failure of the sample product;
analyzing the failure times of the respective sample products under each group of the stress accelerated tests using candidate lifetime models stored in the electronic device to obtain analyzing results, and selecting an optimal lifetime model from the candidate lifetime models based on the analyzing results;
inputting a stress condition corresponding to each group of the stress accelerated tests to the optimal lifetime model to determine a total sample characteristic lifetime corresponding to each group of the stress accelerated tests; and
generating, based on the total sample characteristic lifetime and the stress condition corresponding to each group of the stress accelerated tests, the correspondence relationships between the candidate stress conditions and the candidate characteristic lifetimes;
wherein a formula of the optimal lifetime model is as follows:
$${S}_{k} = exp [ {A}_{0} + {\sum }_{j = 1}^{e} ( {A}_{j} \times δ ( {Y}_{kj} ) ) ]$$
wherein k represents a group number of the accelerated test, e represents a total number of stresses, Yₖⱼ represents the j^{th} stress of the k^{th} group of the accelerated test, A₀, A₁, A₂, . . . , Aⱼ, . . . , Aₑ are unknown parameters, and δ(Yₖⱼ) is a function related to accelerated stress.

2. The method according to claim 1, wherein selecting, based on the performance parameter values of the respective sample products under each group of the stress accelerated tests, the optimal degradation model from the candidate degradation models, comprises:
performing, by using each of the candidate degradation models, a maximum likelihood analysis on the performance parameter values of the respective sample products under each group of the stress accelerated tests to obtain maximum likelihood function values of the respective sample products under each of the candidate degradation models under each group of the stress accelerated tests; and
selecting, based on a sum of the maximum likelihood function values of the respective sample products under each of the candidate degradation models under each group of the stress accelerated tests, the optimal degradation model from the candidate degradation models.

3. (canceled)

4. The method according to claim 1, wherein selecting, based on the failure times of the respective sample products under each group of the stress accelerated tests, the optimal lifetime model from the candidate lifetime models, comprises:
performing, by using each of the candidate lifetime models, a maximum likelihood analysis on the failure times of the respective sample products under each group of the stress accelerated tests, to obtain maximum likelihood function values of the respective sample products under each of the candidate lifetime models under each group of the stress accelerated tests; and
selecting, based on a sum of the maximum likelihood function values of the respective sample products under each of the candidate lifetime models under each group of the stress accelerated tests, the optimal lifetime model from the candidate lifetime models.

5. The method according to claim 1, wherein determining, based on the optimal lifetime model for the type to which the target product belongs and the target characteristic lifetime, the target average lifetime of the target product, comprises:
determining, based on a model type of the optimal lifetime model and a correspondence relationship between model types, the candidate characteristic lifetimes and candidate average lifetimes, a target correspondence relationship; and
determining, based on the target correspondence relationship and the target characteristic lifetime, the target average lifetime of the target product.

6. The method according to claim 2, wherein selecting, based on the sum of the maximum likelihood function values of the respective sample products under each of the candidate degradation models under each group of the stress accelerated tests, the optimal degradation model from the candidate degradation models comprises:
for each candidate degradation model, calculating a sum of the maximum likelihood function values of the respective sample products under the candidate degradation model under each group of stress acceleration tests as a first total likelihood value corresponding to the candidate degradation model; and
taking the candidate degradation model corresponding to the largest first total likelihood value among the candidate degradation models as the optimal degradation model.

7. An apparatus for estimating product lifetime based on a multi-stress accelerated test, the apparatus comprising:
a first determination module configured to determine, in response to a lifetime estimation request for a target product, a target characteristic lifetime of the target product based on a target stress condition for the target product and correspondence relationships between candidate stress conditions and candidate characteristic lifetimes, wherein the correspondence relationships between the candidate stress conditions and the candidate characteristic lifetimes are obtained by processing performance parameter values of respective sample products under different groups of stress accelerated tests, the sample product is of the same type as the target product, and each of the candidate stress conditions comprises at least two types of stresses; and
a second determination module configured to determine, based on an optimal lifetime model for the type to which the target product belongs and the target characteristic lifetime, a target average life of the target product;
wherein the first determination module is configured to:
perform multiple groups of stress accelerated tests to multiple sample products to obtain the performance parameter values of the respective sample products under each group of the stress accelerated tests;
analyze the performance parameter values of the respective sample products under each group of the stress accelerated tests using candidate degradation models to obtain analyzing results, and select an optimal degradation model from candidate degradation models based on the analyzing results;
input preset failure thresholds of the respective sample products under each group of the stress accelerated tests into the optimal degradation model to determine failure times of the respective sample products under each group of the stress accelerated tests, wherein the failure time is a time from the start of the stress accelerated test to the failure of the sample product;
analyze the failure times of the respective sample products under each group of the stress accelerated tests using candidate lifetime models to obtain analyzing results, select the optimal lifetime model from the candidate lifetime models based on the analyzing results;
input a stress condition corresponding to each group of the stress accelerated tests to the optimal lifetime model to determine a total sample characteristic lifetime corresponding to each group of the stress accelerated tests; and
generate, based on the total sample characteristic lifetime and the stress condition corresponding to each group of the stress accelerated tests, the correspondence relationships between the candidate stress conditions and the candidate characteristic lifetime;
wherein a formula of the optimal lifetime model is as follows:
$${S}_{k} = exp [ {A}_{0} + {\sum }_{j = 1}^{e} ( {A}_{j} \times δ ( {Y}_{kj} ) ) ]$$
wherein k represents a group number of the accelerated test, e represents a total number of stresses, Yₖⱼ represents the j^{th} stress of the k^{th} group of the accelerated test, A₀, A₁, A₂, . . . , Aⱼ, . . . , Aₑ are unknown parameters, and δ(Yₖⱼ) is a function related to accelerated stress.

8. The apparatus according to claim 7, wherein the second determination module comprises:
a first determination unit configured to determine, based on a model type of the optimal lifetime model and a correspondence relationship between model types, the candidate characteristic lifetimes and candidate average lifetimes, a target correspondence relationship; and
a second determination unit configured to determine, based on the target correspondence relationship and the target characteristic lifetime, the target average lifetime of the target product.

9. A computer device comprising a processor and a memory, the memory storing computer programs, multiple candidate degradation models, and multiple candidate lifetime models, wherein the computer programs, when executed by the processor, implement steps of a method for estimating product lifetime based on a multi-stress accelerated test, the method comprising:
determining, in response to a lifetime estimation request for a target product, a target characteristic lifetime of the target product based on a target stress condition for the target product and correspondence relationships between candidate stress conditions and candidate characteristic lifetimes, wherein the correspondence relationships between the candidate stress conditions and the candidate characteristic lifetimes are obtained by processing performance parameter values of respective sample products under different groups of stress accelerated tests, the sample product is of the same type as the target product, and each of the candidate stress conditions comprises at least two types of stresses; and
determining, based on an optimal lifetime model for the type to which the target product belongs and the target characteristic lifetime, a target average lifetime of the target product;
wherein processing the performance parameter values of the respective sample products under different groups of the stress accelerated tests comprises:
performing multiple groups of stress accelerated tests to multiple sample products to obtain the performance parameter values of the respective sample products under each group of the stress accelerated tests;
analyzing the performance parameter values of the respective sample products under each group of the stress accelerated tests using candidate degradation models stored in a computer device to obtain analyzing results, and selecting an optimal degradation model from candidate degradation models based on the analyzing results;
inputting preset failure thresholds of the respective sample products under each group of the stress accelerated tests into the optimal degradation model to obtain failure times of the respective sample products under each group of the stress accelerated tests, wherein the failure time is a time from the start of the stress accelerated test to the failure of the sample product;
analyzing the failure times of the respective sample products under each group of the stress accelerated tests using candidate lifetime models stored in the computer device to obtain analyzing results, and selecting an optimal lifetime model from the candidate lifetime models based on the analyzing results;
inputting a stress condition corresponding to each group of the stress accelerated tests to the optimal lifetime model to determine a total sample characteristic lifetime corresponding to each group of the stress accelerated tests; and
generating, based on the total sample characteristic lifetime and the stress condition corresponding to each group of the stress accelerated tests, the correspondence relationships between the candidate stress conditions and the candidate characteristic lifetimes;
wherein a formula of the optimal lifetime model is as follows:
$${S}_{k} = exp [ {A}_{0} + {\sum }_{j = 1}^{e} ( {A}_{j} \times δ ( {Y}_{kj} ) ) ]$$
wherein k represents a group number of the accelerated test, e represents a total number of stresses, Yₖⱼ represents the j^{th} stress of the k^{th} group of the accelerated test, A₀, A₁, A₂, . . . , Aⱼ, . . . , Aₑ are unknown parameters, and δ(Yₖⱼ) is a function related to accelerated stress.
